(19) United States
(12) Patent Application Publication
(10) Pub. No.: US 2010/0177511 A1
(43) Pub. Date: Jul. 15, 2010

(54) LED LUMINESCENT LIGHT BAR

(76) Inventor: Qing-Lu YU, Taichung County (TW)

Correspondence Address: Ching-Ling Huang, 5597 NW 127th Ter, Portland, OR, 97229, US

(21) Appl. No.: 12/351,817

(22) Filed: Jan. 10, 2009

(51) Int. Cl. F21V 21/008

(52) U.S. Cl. 362/217.05

(57) ABSTRACT

An LED luminescent light bar hung under a ceiling to hold a light bar with an LED as a light source includes at least one reflective back board made of extruded aluminum, at least one light bar, a driving means, at least one transparent lamp shade, two side plates and two hanging elements. The light bar and the driving means are installed on the reflective back board. The driving means is connected to the light bar to generate light. The transparent lamp shade and the two side plates also are installed on the reflective back board to seal the light bar. The light bar is installed under the ceiling through two hanging elements. The reflective back board provides higher reflection and greater heat dissipation, thus allows the light energy of the LEDs to be fully utilized to enhance luminescence. Heat can be dispelled quickly to avoid overheated and burn down.

### FIELD OF THE INVENTION

The present invention relates to an LED (light-emitting diode) lighting bar lamps and particularly to an LED luminescent light bar for hanging on a ceiling.

### BACKGROUND OF THE INVENTION

LED can save electric power and provide higher lighting efficiency, thus has become a new generation lighting-means-of-choice and is widely used in various types of luminescent equipment. However, for indoor luminescence, a single LED still cannot generate as much brightness as the conventional fluorescent lamp or halogen lamp does. To provide sufficient brightness in doors, multiple LEDs have to be clustered together.

While one LED generates only limited amount of heat, clustering a great number of LEDs together when in use generates significant amount of heat that can degenerate the LEDs quickly. Lighting function also suffers rapidly. Hence the conventional technique of adopting the LEDs for lighting purpose often has to incorporate heat dispersing system such as air fans to dispel heat. Such an approach increases production cost and generates noises. Hence there are still rooms for improvement.

### SUMMARY OF THE INVENTION

Therefore, the primary object of the present invention is to provide an LED luminescent light bar that can be fabricated easily and cluster at least one light bar, and installed under a ceiling to meet general lighting requirement.

To achieve the foregoing object, the LED luminescent light bar according to the invention aims to hold the light bar with an LED. It includes a reflective back board made of extruded aluminum, at least one light bar with the LED, a driving means, at least one transparent lamp shade, two side plates and two hanging elements. The reflective back board is elongate and has a plurality of heat sinks at the top thereof and a housing space at the bottom. The light bar is located in the housing space. The driving means is connected to the light bar to drive the light bar to generate light. The transparent lamp shade is installed on the reflective back board to cover the housing space. The two side plates are installed at the left side and right side of the reflective back board to seal the light bar in the housing space. The two hanging elements are fastened to the top of the reflective back board to hang the light bar under a ceiling.

Thus the invention can cluster and hold at least one light bar to function as a general light source. The reflective back board provides higher reflection and greater heat dissipation effect to enhance light source utilization efficiency and quickly dispel heat and prevent overheat. It can better meet users' requirements.

The foregoing, as well as additional objects, features and advantages of the invention will be more readily apparent from the following detailed embodiments and description, which proceeds with reference to the accompanying drawings. The embodiments serve only for illustrative purpose and are not the limitations of the invention.

### BRIEF DESCRIPTION OF THE DRAWINGS

FIG. 1A is an exploded view of a first embodiment of the invention.

FIG. 1B is a fragmentary enlarged view of FIG. 1A.

FIG. 2 is a perspective view of the first embodiment of the invention.

FIG. 3 is an exploded view of a second embodiment of the invention.

FIG. 4 is a perspective view of the second embodiment of the invention.

FIG. 5 is a perspective view of a third embodiment of the invention.

FIG. 6 is a fragmentary perspective view of the third embodiment showing the hanging element and the fastening element.

FIG. 7 is a fragmentary perspective view of the third embodiment showing the fastening portion and the fastening element.

### DETAILED DESCRIPTION OF THE PREFERRED EMBODIMENTS

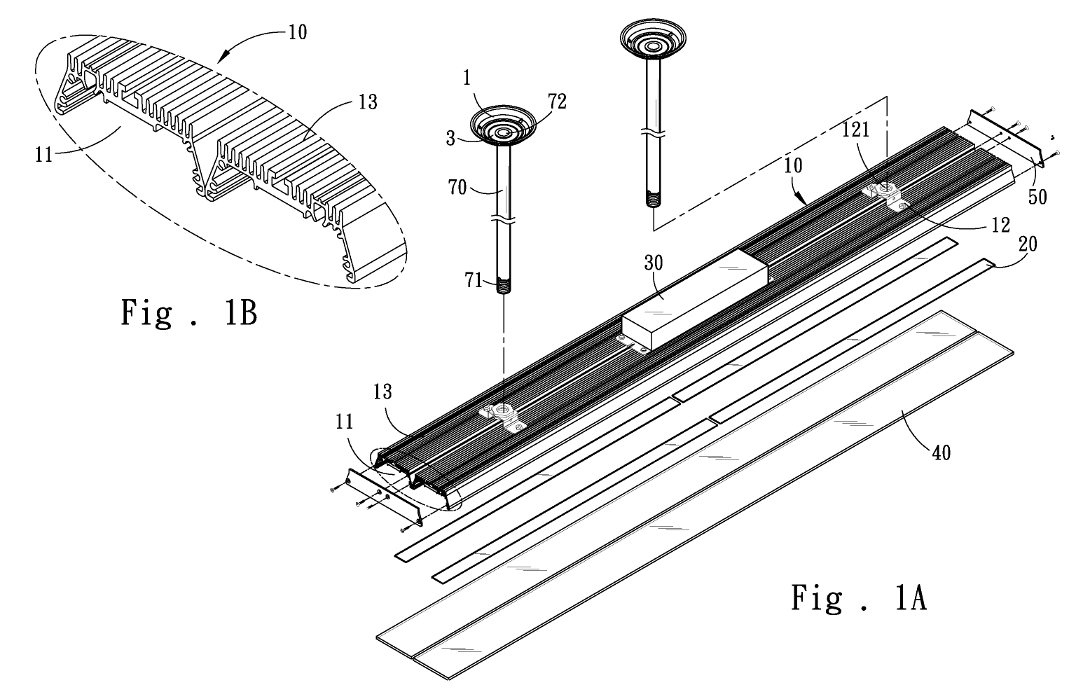

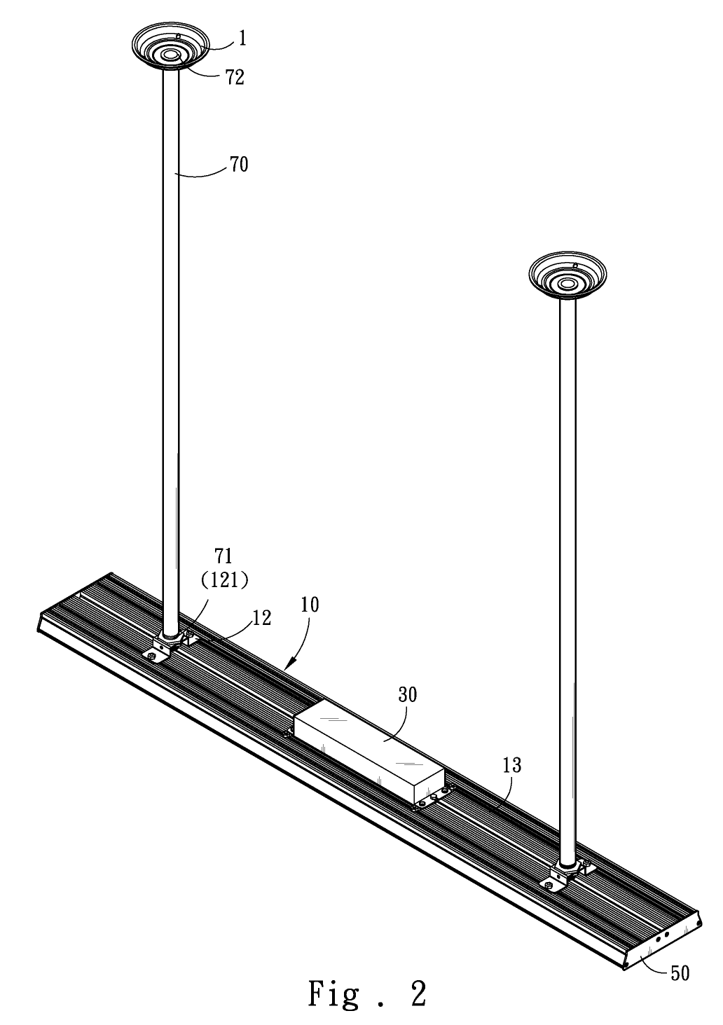

Please refer to FIGS. 1A, 1B and 2 for a first embodiment of the LED luminescent light bar of the invention. It includes a reflective back board 10 made of extruded aluminum, at least one light bar with an LED20, a driving means 30, at least one transparent lamp shade 40, two side plates 50 and two hanging elements 70 on a left side and a right side to hang the light bar under a ceiling to generate light. The ceiling has at least two fastening elements 1, each is a hollow cap with an upward opening and has a bottom wall 3 with a through hole (not shown in the drawings) formed thereon.

The reflective back board 10 which can be composed of one or plural is elongate and has a plurality of heat sinks 13 at the top thereof and at least two parallel housing spaces 11 at the bottom. The top of the reflective back board 10 further has two fastening portions 12 on the left side and the right side with at least one screw hole 121 formed thereon.

The light bar 20 can be single or plural paralleled arranged in the housing spaces 11.

The driving means 30 is connected to a power supply (not shown in the drawings) and located at the top of the reflective back board 10, and connected to the light bar 20 to provide voltage to drive the light bar 20 to generate light. The transparent lamp shade 40 is installed on the bottom of the reflective back board 10 to cover the housing spaces 11. The light bar 20 emits light to pass through the transparent lamp shade 40 and be dispersed evenly. The two side plates 50 are installed at the left side and right side of the reflective back board 10 to seal the housing spaces 11 and cover the light bar 20 by incorporating with the transparent lamp shade 40.

The two hanging elements 70 are rods each has an upper end and a lower end. The upper end of the hanging element 70 has a flange 72. The lower end has a thread section 71 fastening to the screw hole 121 at the top of the reflective back board 10. The hanging element 70 first runs through the through hole of the fastening element 1 with the flange 72 resting on the bottom wall 3 of the fastening element 1 to be fastened to the ceiling.

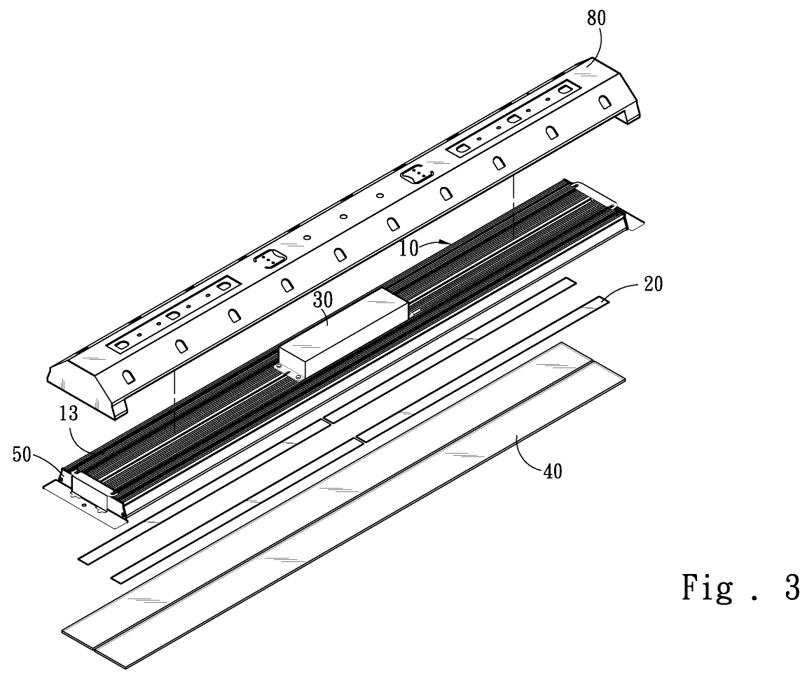

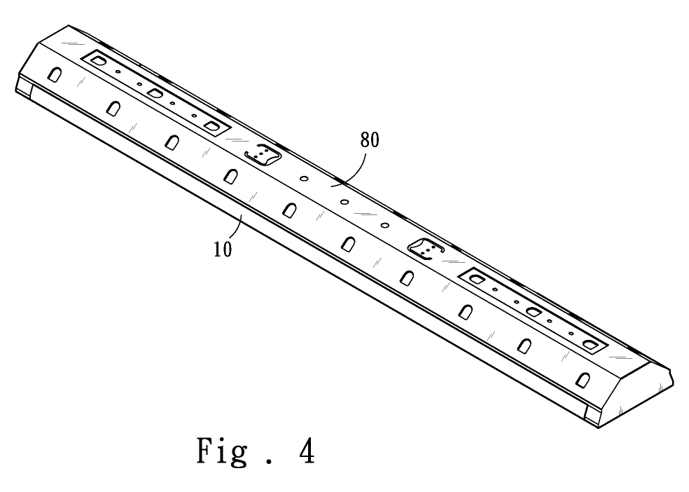

FIGS. 3 and 4 show a second embodiment of the invention, and it is roughly the same as the first embodiment. An upper cover 80 is mounted onto the reflective back board 10, and matches the width of the reflective back board 10 to cover the top of the reflective back board 10, so that the driving means 30 is covered inside. The reflective back board 10 does not have the fastening portion 12. The reflective back board 10 is directly fastened to the upper side of the ceiling when assembling, not installed by the two hanging elements 70.

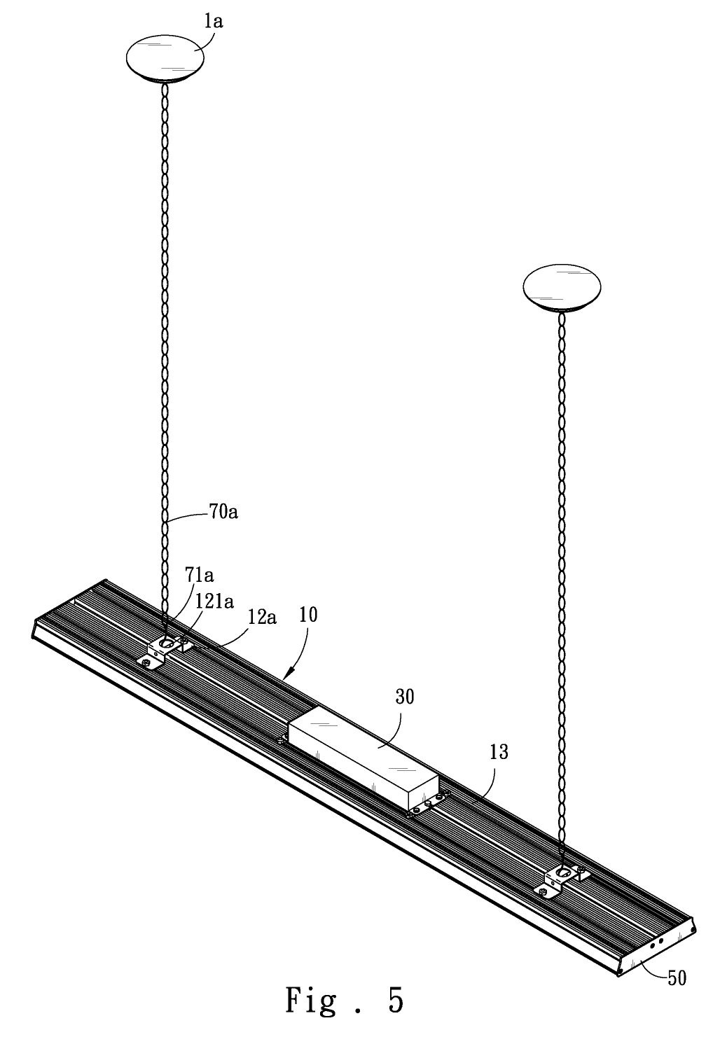

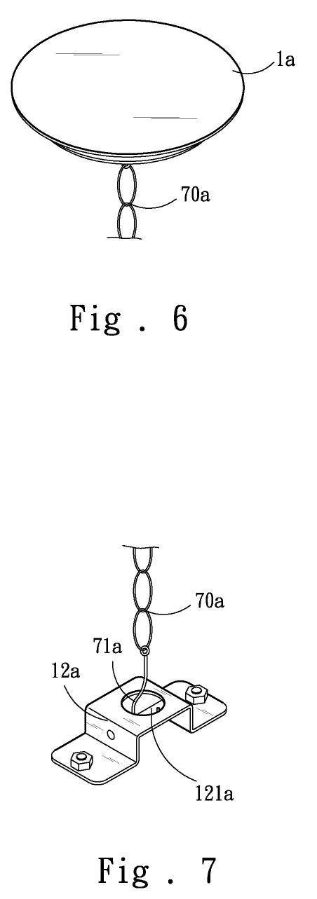

Refer to FIGS. 5, 6 and 7 for a third embodiment of the invention. It is substantially constructed like the first embodiment. The main difference is that it has two hanging elements 70a formed in chains each has hooks 71a at an upper end and a lower end thereof. The reflective back board 10 has a fastening portion 12a with a hanging bar 121a located thereon to be hooked by the hook 71a at the lower end of the hanging element 70a. A fastening element 1a is provided to fasten to the ceiling. The upper end of the hanging element 70a is coupled with the fastening element 1a.

By means of the structures set forth above, the invention provides at least one light bar 20 hung under the ceiling, preferably white light, but not so limited. The light is generated in a clustered manner, thus can produce sufficient brightness to serve as a light source for general use. As the reflective back board 10 is made from extruded aluminum that can provide great reflection and has the heat sinks 13 at the top to provide efficient heat dissipation, higher light source utilization efficiency can be achieved and heat can be dispelled quickly to prevent overheat. Thus life span of the light bar 20 increases and malfunction can be reduced to better meet users' requirements.

What is claimed is:

1. An LED luminescent light bar hung under a ceiling, comprising:
at least one reflective back board which is made of elongated and extruded aluminum and has a plurality of heat sinks at the top and at least two parallel housing spaces at the bottom thereof;
at least one light bar which is held in the housing spaces and can generate light;
a driving means connecting to the light bar to drive the light bar to generate light;
a transparent lamp shade located at the bottom of the reflective back board to cover the housing spaces;
two side plates located at a left side and a right side of the reflective back board to incorporate with the transparent lamp shade to seal the housing spaces; and
at least two hanging elements each having a lower end connected to the reflective back board and an upper end fastened to the ceiling.

2. The LED luminescent light bar of claim 1, wherein the driving means is located at the top of the reflective back board.

3. The LED luminescent light bar of claim 1, wherein the driving means is connected to a power supply to provide electric power needed by the light bar.

4. The LED luminescent light bar of claim 1, wherein the hanging elements are rods each having an upper end formed a flange and a lower end formed a thread section, the reflective back board having a fastening portion at the top containing a screw hole fastened to the thread section, the ceiling having at least two fastening elements each being a hollow cap and having a bottom wall formed with a through hole run through by the hanging element, the flange being rested on the bottom wall of the inner side of the fastening element.

5. The LED luminescent light bar of claim 1, wherein the two hanging elements are chains each having a lower end fastened to a hook, the top of the reflective back board having a fastening portion which has a hanging bar hooked by the hook at the lower end of the hanging element, the ceiling having at least two fastening elements, and the upper end of the hanging element is coupled with the fastening element.

6. An LED luminescent light bar hung under a ceiling, comprising:
at least one reflective back board which is made of elongated and extruded aluminum and has a plurality of heat sinks at the top and at least two parallel housing spaces at the bottom thereof;
at least one light bar which is held in the housing spaces and can generate light;
a driving means which is located at the top of the reflective back board connecting to the light bar to drive the light bar to generate light;
at least one transparent lamp shade located at the bottom of the reflective back board to cover the housing spaces;
two side plates located at a left side and a right side of the reflective back board to incorporate with the transparent lamp shade to seal the housing spaces; and
an upper cover matches the width of the reflective back board to cover the top of the reflective back board to cover the driving means inside.

7. The LED luminescent light bar of claim 6, wherein the driving means is connected to a power supply to provide electric power needed by the light bar.
